(19) United States
(12) Patent Application Publication
(10) Pub. No.: US 2025/0231745 A1
(43) Pub. Date: Jul. 17, 2025

(54) METHODS, APPARATUSES AND COMPUTER PROGRAM PRODUCTS FOR GENERATING PORTIONS OF CODE AND PROVIDING A RISK AND COMPLIANCE ARTIFICIAL INTELLIGENCE VIRTUAL ASSISTANT

(71) Applicant: Meta Platforms, Inc., Menlo Park, CA (US)

(72) Inventors: William Moten, Rockville, MD (US); Hardik Punjabi, San Jose, CA (US); Zhiyu Liu, Mountain View, CA (US); Nehal Sheth, San Francisco, CA (US); Shreyas Shrivastava, Newark, CA (US); Vasanth Chandrasekaran, Cupertino, CA (US); Carissa Ann Melasippo, Montville, NJ (US); Nathalie Saade, San Francisco, CA (US); Deepak Agrawal, Grapevine, TX (US); Jordan David Kendall, Bothell, WA (US); Brian Walters, Santa Clarita, CA (US)

(21) Appl. No.: 19/000,603

(22) Filed: Dec. 23, 2024

Related U.S. Application Data
(60) Provisional application No. 63/621,988, filed on Jan. 17, 2024.
(60) Provisional application No. 63/695,047, filed on Sep. 16, 2024.

(51) Int. Cl. G06F 8/35

(52) U.S. Cl. CPC G06F 8/35

(57) ABSTRACT

Systems, and methods are described for a ML model generating sections of code based on inputs. The systems of generating code may receive inputs. The first input may be a description of problems for solving and a specification of an output. The second input may be variables. The third input may be data categories associated with the variables and the output. The fourth input may be responses to prompts. The prompts may be generated by a ML model based on association between the first, second, and third inputs. Boilerplate sections of code may be determined by the ML model. Missing portions of code are determined. Missing portions of code may be associated with core sections of code. The ML model may utilize the inputs to generate code to fill in missing portions of code. Generated code including missing portions and sections of generated code are provided to a user interface.

### CROSS-REFERENCE TO RELATED APPLICATIONS

This application claims priority to U.S. Provisional Application No. 63/621,988, filed Jan. 17, 2024, entitled “Risk And Compliance Artificial Intelligence Virtual Assistant” and U.S. Provisional Application No. 63/695,047, filed Sep. 16, 2024, entitled “Methods, Apparatuses And Computer Program Products For Generating Portions Of Code,” both of which are incorporated by reference herein in their entirety.

### TECHNOLOGICAL FIELD

The present disclosure generally relates to methods, apparatuses, and computer program products for programming, specifically implementing machine learning models in automatic code generation.

### BACKGROUND

In development of software or tools that may require code, reducing development time and maintenance time may be an important goal for developers and entities. One such approach to reduce development time and maintenance time of program code may be the use of automatic code generation tool(s). In some examples, automatic code generation tools may require a developer or user to write core lines of code for the automatically generated code to function in a manner suitable to the developer or users interest.

As such, there may be a need for more efficient and effective code generation tool that may completely generate a program code.

### BRIEF SUMMARY

Various systems, methods, and devices are described for a system(s) and/or machine learning model(s) configured to generate code based on one or more user inputs.

The exemplary aspects of the present disclosure may provide a machine learning model configured to generate code associated with one or more user inputs. The one or more user inputs may include a description, one or more variables, or a number of responses to a number of prompts generated by a machine learning model.

In various examples, systems, methods, and devices of the present disclosure may generate code associated with received one or more inputs. The one or more inputs may be a description associated with actions the user may want the code to perform. The one or more inputs may include definitions to one or more variables associated with determining an output. The one or more inputs may include one or more responses to one or more prompts generated by a machine learning model. A machine learning model(s) associated with the system may be trained on previously generated codes, similar code outputs, or the like. The machine learning model(s) may be utilized to generate one or more prompts based on a relationship between one or more words, terms, or phrases. In some examples, the machine learning model may utilize/implement a nearest neighbor approach to determine a relationship between the words, terms, or phrases. The generated code may be utilized to provide the output associated with the description associated with one of the one or more inputs.

The machine learning model may determine one or more prompts associated with a relationship between words or information associated with associated with a provided description associated with one of the one or more inputs, an indicated output, variable descriptions, or previous responses to generated prompts. The machine learning model(s) may embed in a vector space the words, terms, phrases, sentences, or the like as a vector(s). The machine learning model(s) may utilize a nearest neighbor application and/or a nearest neighbor algorithm in conjunction with the vector space to determine a relationship between words. Based on the closeness of two or more vectors in a vector space an annotation(s) may be predicted or determined. In some examples, the machine learning model(s) may be trained based on statistical models to analyze vast amounts of data, learning patterns and/or connections between words, phrases, natural language patterns, or previously learned responses to prompts. The machine learning model(s) may facilitate providing one or more prompts to a user via a graphical user interface.

The machine learning model may generate a code associated with the one or more inputs received. The generated code may be generated based on a relationship between one or more responses to one or more prompts generated by a machine learning model (e.g., in some examples may be the same or different machine learning model), a description, an indicated output, variable descriptions, or previously generated code. The generated code may be generated and provided on a graphical user interface of a device (e.g., computing device, communication device, or the like). The generated code may be utilized to train the machine learning model to improve accuracy of the code generation tool.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an example system in accordance with an example of the present disclosure.

FIG. 2 illustrates an example method in accordance with an example of the present disclosure.

FIG. 3 illustrates an example computing device in accordance with an example of the present disclosure.

FIG. 4 is a diagram of an exemplary computing system in accordance with an example of the present disclosure.

FIG. 5 illustrates a machine learning and training model, in accordance with an example of the present disclosure.

FIG. 6 illustrates an example user interface generated by a Governance, Risk, and Compliance chatbot in accordance with an exemplary aspect of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

### A. Methods, Apparatuses, Systems and Computer Program Products for Generating Portions of Code

Conventionally, programming languages are used by programmers in writing programs (e.g., applications, tools, or the like). Developers or programmers may utilize many different high level programming languages such as but not limiting to, C++, C, Java, Python, JavaScript, Ruby, or the like. Many programs written in these programming languages may require extensive knowledge in a particular programming language and time to complete or utilize. In an increasingly computer driven environment the extensive time it takes to create or write a program may make the role of many developers and users more difficult. Alternatively, in some examples, as the use of computers is increasing there may be instances where a user (e.g., developer, individual, or the like) not trained in a particular programming language may need to create a program utilizing the programming language the user may not have knowledge in. In many examples, a user's programming ability or knowledge as well as the user's ability to interact with a computer system may become a limiting factor in utilization of the computer system.

Some conventional, methods to combat these issues may be code generation tools. However, in some examples, code generation tools may require a user to write (e.g., or code) numerous lines of core code or as referred to herein as manual sections. In many examples, conventional code generation tools generate known boiler plate code and leave a number of open sections (e.g., manual sections) in the code for a human programmer to fill in. In some examples, the manual sections of the generated code may include space to provide or write the main functionality or unit tests of the generated code. In many cases, to write the manual sections may take increasingly more time depending on the complexity of the code generated and the programming knowledge of the user. As such, the example aspects of the present disclosure may utilize a machine learning model(s) to generate the manual sections of a generated code.

The term “manual section(s)” as referred to herein may refer to one or more portions or sections of a generated code that may be intentionally left not generated or partially generated, requiring manual editing or completion by a user. The manual section may allow users to insert custom logic, handle complex scenarios, or integrate third-party code that conventionally cannot be automatically generated by the code generator. In some examples, the manual section may enable users to refine or optimize the generated code to better suit their specific requirements or performance needs.

In some examples, manual sections associated with generated code, may lead to extensive downstream intervention, time delays, or extensive errors with boilerplate code not sufficiently matching the manual section provided by a user. The writing of manual sections may result in costly consequences as the user may be required to spend a significant amount of time writing the manual section. For instance, consider a complex code was generated requiring a user to provide code for a manual section. In this example, it may take the user many hours to days to complete the manual section such that the generated code may be used. As such, there may be a need for a more efficient and effective code generation tool that may generate conventional manual sections using a machine learning model(s). As such, example systems and methods of the present disclosure described herein may lead to more efficient, cost-effective, and more accurate generated code.

This disclosure may be described in the general context of customized hardware capable of executing customized preloaded instructions such as, e.g., computer-executable instructions for performing program modules. Program modules may include one or more of routines, programs, objects, variables, commands, scripts, functions, applications, components, data structures, and so forth, which may perform particular tasks or implement particular abstract data categories. The disclosed embodiments may also be practiced in distributed computing environments where tasks are performed by remote processing devices that are linked through a network. In a distributed computing environment, program modules may be located in local and/or remote storage including memory storage devices.

Examples of the present disclosure increase the efficiency and accuracy of methods for generating computer programming code and standalone computer code functions, as well as building one or more portions of programming code, from one or more inputs comprising natural language text. For instance, a machine learning model consistent with disclosed examples may provide boiler plate sections of code in response to a user input describing a problem to be solved in natural language (e.g., a description). In response to boiler plate sections being generated, the machine learning model may generate one or more prompts to determine and/or generate code associated with conventional manual sections. As a result, the user may not be required to have any programming knowledge or experience in order to create executable code which provides a solution to the problem. In some examples, the machine learning model may be trained using incredibly large datasets of code and/or natural language, enabling the model to learn to generate functionally accurate code in response to natural language input.

As a result, a user may not be required to have any programming knowledge or experience in order to understand the purpose or functionality associated with that computer code. The present disclosure further improves the machine learning model(s) performance by providing methods and systems for fine-tuning trained machine learning models based on known correctly implemented functions, known associations, and other known data.

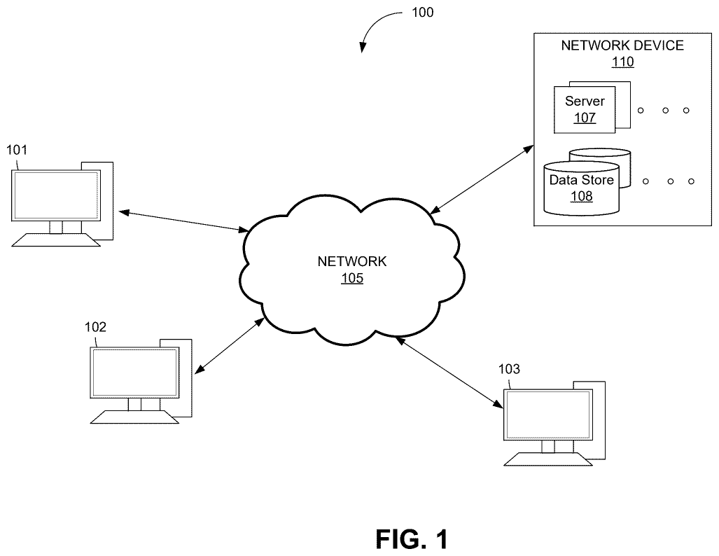

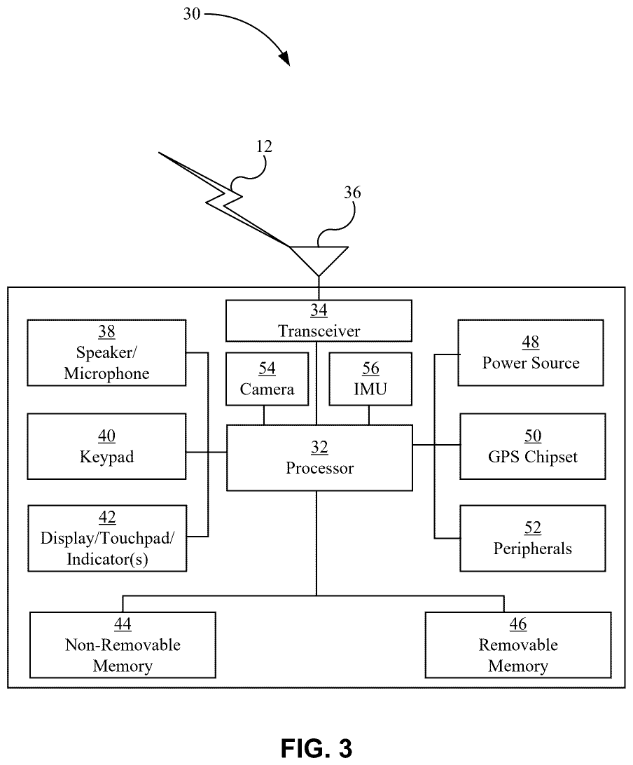

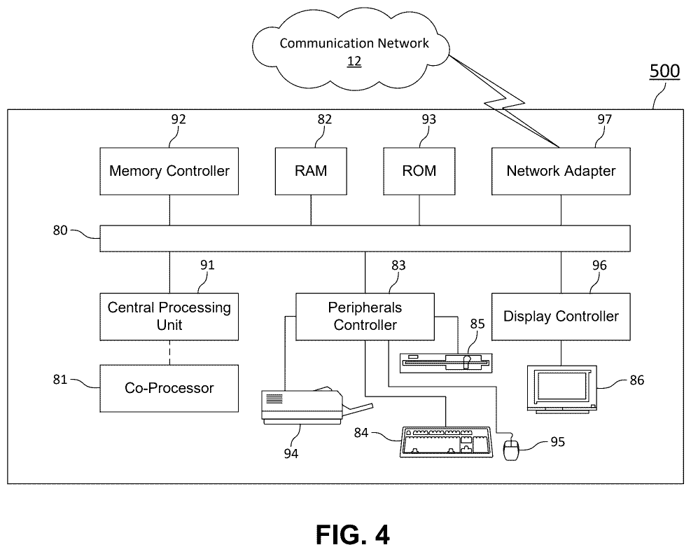

FIG. 1 illustrates an example system 100 according to example aspects of the present disclosure. The system 100 may be capable of facilitating the transmission of data among users, servers, databases, or any combination thereof. The system 100 may include one or more communication devices 101, 102, 103 (also may be referred to herein as user devices 101, 102, 103), server 107, data store 108, or network device 110. In some examples, communication devices 101, 102, and 103 may be examples of user equipment (UE) (e.g., UE 30 of FIG. 3). As shown for simplicity, network device 110 may comprise one or more servers (e.g., server 107) and one or more data stores (e.g., data store 108). In some examples, the network device 110 may be a computer system (e.g., computer system 500 of FIG. 4) capable of hosting or delivering internet based content or other content to users associated with a code generation tool over a network 105 (e.g., the internet) via a web browser. In some examples, it is contemplated that the network device 110 may be a standalone device. In other examples, the network device may be located on a server. It is contemplated that network device 110 may interact and/or communicate with one or more devices (e.g., communication devices 101, 102, 103) of system 100.

In some examples, communication device 101, communication device 102 and communication device 103 may be associated with an individual (e.g., a user), entity (e.g., organization), or the like that may interact or communicate with an code generation tool or application(s), or platform(s) associated with network device 110. The network device 110 may be considered, or associated with, an application(s), platforms(s), a code generation tool(s), and/or the like. In some examples, one or more users may use one or more devices (e.g., communication device 101, communication device 102, communication device 103) to access, send data to, and/or receive data from network device 110. In some examples, one or more entities may use one or more devices (e.g., communication device 101, communication device 102, communication device 103) to access, send data to, and/or receive data from network device 110.

This disclosure contemplates any suitable network 105. As an example and not by way of limitation, one or more portions of network 105 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 105 may include one or more networks 106.

The communication devices 101, 102 and 103 may be an electronic device including hardware, software, or embedded logic components or a combination of two or more such components and capable of carrying out the appropriate functionalities implemented or supported by the communication devices 101, 102, 103. As an example and not by way of limitation, communication devices 101, 102, 103 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., communication devices 101, 102, 103). One or more of the communication devices 101, 102, 103 may enable a user to access network 105. One or more of the communication devices 101, 102, 103 may enable a user(s) to communicate with other users at other communication devices 101, 102, 103.

In particular examples, system 100 may include one or more servers 107. Each of the servers 107 may be a unitary server or a distributed server spanning multiple computers or multiple datacenters. Servers 107 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 107 may include hardware, software, or embedded logic components or a combination of two or more such components for carrying out the appropriate functionalities implemented or supported by server 107.

In particular examples, system 100 may include one or more data stores 108. Data stores 108 may be used to store various types of information. In particular examples, the information stored in data stores 108 may be organized according to specific data structures. In particular examples, each of the data stores 108 may be a relational, columnar, correlation, or other suitable database. Although this disclosure describes or illustrates particular types of databases, this disclosure contemplates any suitable types of databases. Particular examples may provide interfaces that enable communication devices 101, 102, 103 or another system (e.g., a third-party system) to manage, retrieve, modify, add, or delete, the information stored in data store 108.

In some examples, network device 110 may be a network-addressable computing system that may host an online search network. The network device 110 may store, receive, process, or analyze data. In examples, network device 110 may facilitate data interactions between clients (e.g., users), databases, and entities (e.g., organizations). In an example, the network device 110 may retrieve data from data bases (e.g., data store 108) and execute data mining processes or methods to extract information associated with the data. The network device 110 may be configured to handle a vast volume of data generated from a number of sources such as but not limited to web pages, social media platforms, or the like. The network device 110 may be configured to retrieve, process, or analyze data based on a request, where in response the network device 110 may retrieve relevant data from databases (e.g., data store 108), servers (e.g., server 107), or any other device of system 100. In some examples, network device 110 may be configured to perform methods or processes associated with data mining to generate a result associated with the request received.

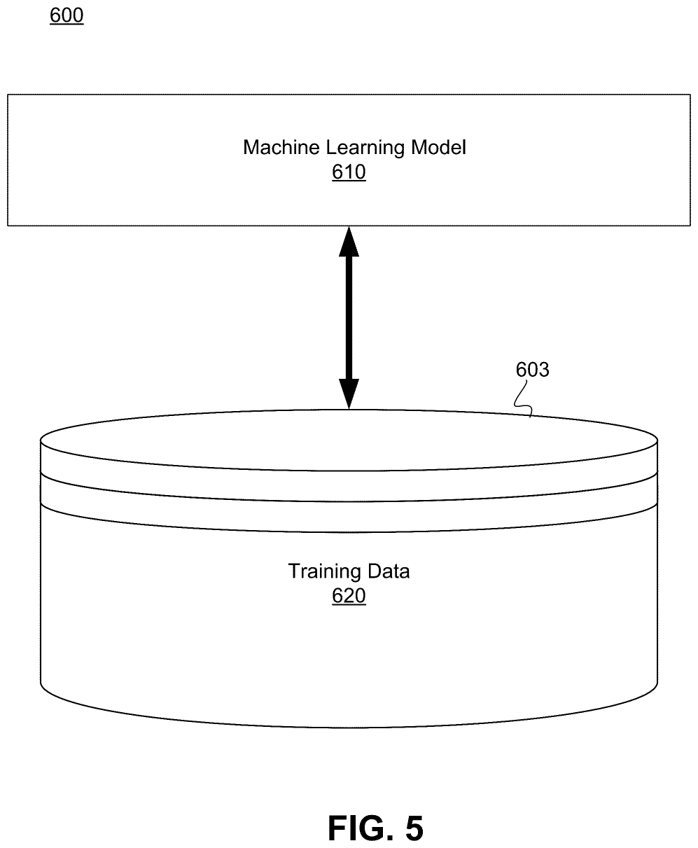

In some examples, network device 110 may be configured to assess and receive one or more inputs, which may be associated with a user profile. The one or more inputs may refer to textual natural language input that may provide a description, definition, context, and/or structure associated with the code to be generated. The one or more inputs may include, a description, one or more variables and variable definitions, output form, or one or more responses to one or more generated prompts. In some examples, network device 110 may be configured to utilize the received description and indicated output (e.g., output form) to contextualize the request of the user to determine one or more boilerplate sections of code. In some alternate examples, a machine learning model (e.g., machine learning model 610 of FIG. 5) may be utilized to assess the context of the description in association to the output form to determine or generate the boilerplate code. In some examples, the boilerplate code may refer to consistently formatted code that is generic to a specific input or received description. Boilerplate code may be referred to as a template or a basic outline that may be used over and over again when programming using software. The same basic parts of code may not be created from scratch every time-instead, details associated with differences may be filled in that are different for each project.

In some examples, network device 110 may be configured to utilize one or more machine learning models (e.g., machine learning model 610 of FIG. 5) to generate one or more prompts to aid in the determination or generation of code associated with conventional manual sections. In some traditional and existing systems and methods of code generation, the presence of manual sections may result in significant time and programming knowledge being needed to create a working program code. Conversely, the network device 110 of the examples of the present disclosure may be configured to generate conventional manual sections based on one or more responses associated with the one or more prompts generated. In some examples, the network device 110 may be configured to utilize the generated prompts or manual sections to train one or more machine learning models (e.g., machine learning model 610) to optimize future manual section code generation or prompt generation.

Although FIG. 1 illustrates a particular arrangement of communication device 101, communication device 102, communication device 103, network 105, server 107, data store 108, and/or network device 110, among other things, this disclosure contemplates any suitable arrangement. The devices of system 100 may be physically or logically co-located with each other in whole or in part.

It should be pointed out that although FIG. 1 shows one network device 110, server 107, data store 108 and three communication devices 101, 102, and 103, any suitable number of network devices 110, communication devices 101, 102, 103, servers 107, and data stores 108 may be part of the system 100 of FIG. 1 without departing from the spirit and scope of the present disclosure.

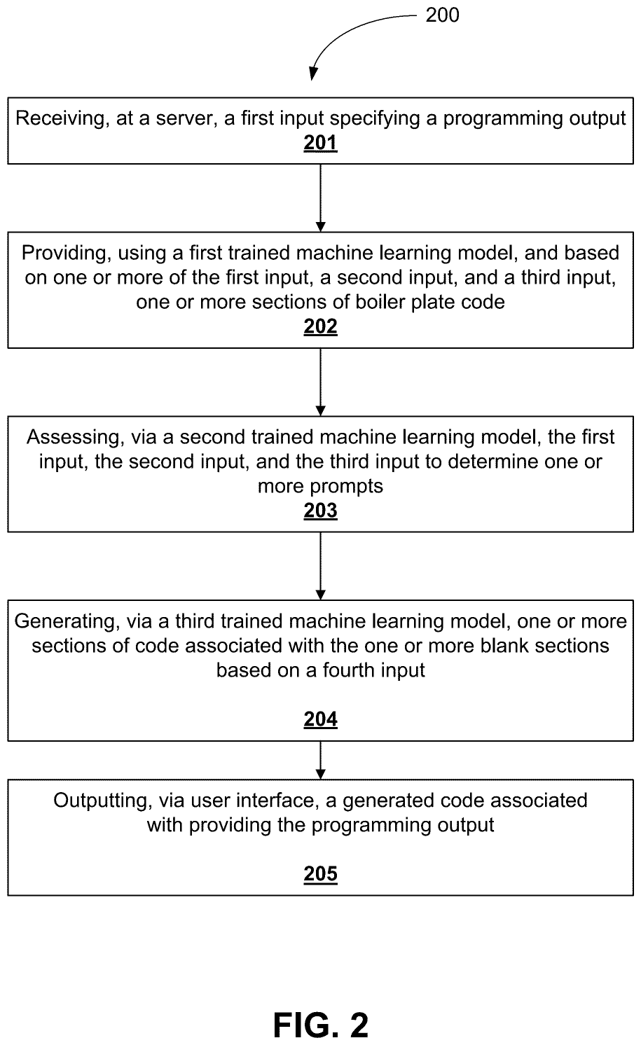

FIG. 2 illustrates an example method 200 for generating programming code as disclosed herein. The method 200 may utilize a machine learning model(s) 610 configured to generate one or more sections of program code. In some examples, the machine learning model may be a large language model. At step 201, a first input specifying a programming output (e.g., output) may be received at a server. The first input may comprise a description that describes a problem to be solved in text (e.g., natural language).

At step 202, based on one or more of the first input, a second input, and a third input, one or more sections of boiler plate code may be determined via a machine learning model 610 (e.g., a first machine learning model). The boiler plate code may comprise one or more missing portions. The missing portions may be associated where traditional manual sections were located in conventional or traditional code generation tools. In some examples, a database (e.g., data store 108) may be referenced to determine one of the one or more sections of boiler plate code. In some examples, locations associated with the one or more missing portions of code may be stored in the data store 108 with the one or more section of boiler plate code. In some examples, the second input may define one or more variables. The one or more variable may be of any data category such as but not limiting to, floating point, Boolean, integer, string, function, vector, array, matrix, mesh, or any other suitable data category. In some examples, the third input may define a data category associated with the one or more variables and the programming output (e.g., output). The third input may be defined as any suitable data category. In some examples the differences in data category between the one or more variables and the programming output may aid in the determination of the one or more prompts determined at step 203. In some alternate examples, the location of the one or more missing portions may be transmitted to the server (e.g., server 107) and utilized in the following steps such that generated code may be generated (e.g., written) in the correct places.

At step 203, via the machine learning model 610 (e.g., a second trained machine learning model), the first input and the programming output may be assessed to determine one or more prompts to obtain information to generate one or more sections of code. The second trained machine learning model may be a large language model (LLM) configured to embed, or otherwise associate, contextual data associated with the one or more inputs (e.g., first input and second input) to predict or determine one or more prompts associated with the problem to be solved as defined in the description (e.g., the first input). The machine learning model(s) may be trained to utilize instances of text for reuse (e.g., in instances in which names or descriptions are reused) to generate or determine one or prompts associated with the one or more inputs. The machine learning model (e.g., the second trained machine learning model) may be trained based on in part by data stored in databases (e.g., training databases 603), or the like. The training data the machine learning model(s) may be trained on may include associations between textual inputs (e.g., one or more inputs) and a programming output, metadata, code snippets, or the like, and may be used to teach or train the machine learning model(s) general understanding of the similarity between textual components. In some examples, the machine learning model(s) may be associated with any large language model. The large language model(s) may be configured to capture and assess a large range of language patterns, context associated with the language patterns, and/or semantic meanings. The large language model(s) may be configured to determine semantic similarities between different data textual inputs, names and/or descriptions.

At step 204, via the machine learning model 610 (e.g., a third trained machine learning model), one or more sections of code associated with the one or more missing portions may be generated based on a fourth input. The fourth input may comprise one or more responses to the determined (e.g., generated) prompts.

At step 205, a generated code associated with the programming output (e.g., associated with the description) may be outputted via a user interface. The generated code may comprise the one or more sections of boiler plate code and the one or more sections of code generated at step 204. In some examples, the generated code may also comprise one or more comments to describe functions and processes associated with the generated code. In some examples, the comments may be provided and configured to aid a user in understanding the generated code.

It is contemplated that the method 200 may be performed via one or more machine learning models or by one machine learning model. It is further contemplated that the method 200 may be performed iteratively, wherein the generated code may be utilized to further train and fine-tune the machine learning model(s). It is contemplated that the one or more inputs may be any suitable input associated with the code generation tool, which would be apparent by those skilled in the art.

For many existing systems, manually writing the one or more missing portions (e.g., manual sections) typically requires extensive time, resources and expert knowledge to build a model that may be inefficient and less accurate than desired. The machine learning model of the example aspects of the present disclosure overcomes these drawbacks of existing code generation tools. The example aspects of the present disclosure represent significant advancements in the field of code generation. By leveraging contextual data associated with the one or more inputs and the machine learning model(s) (e.g., machine learning model 610), the example aspects of the present disclosure provide an efficient solution for generating code that does not require programming knowledge or a user writing code, thereby improving time it takes to write code and allowing for wider access to code creation.

FIG. 3 illustrates a block diagram of an example hardware/software architecture of user equipment (UE) 30. As shown in FIG. 3, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, an inertial measurement unit (IMU) 56, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

FIG. 4 is a block diagram of an exemplary computing system 500. In some exemplary embodiments, the network device 110 may be a computing system 500. The computing system 500 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 500 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 500 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 500. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 500 may contain communication circuitry, such as for example a network adaptor 97, that may be used to connect computing system 500 to an external communications network, such as network 12 of FIG. 3, to enable the computing system 500 to communicate with other nodes (e.g., UE 30) of the network.

FIG. 5 illustrates a framework 600 associated with machine learning and/or artificial intelligence (AI). The framework 600 may be hosted remotely. Alternatively, the framework 600 may reside within the system 100 shown in FIG. 1 and may be processed/implemented by a device. In some examples, the machine learning model 610 (also referred to herein as artificial intelligence model 610) may be implemented/executed by a network device (e.g., network device 110). In other examples, the machine learning model 610 may be implemented/executed by other devices (e.g., communication devices 101, 102, 103). The machine learning model 610 may be operably coupled with the stored training data in a training database 603 (e.g., data store 108). In some examples, the machine learning model 610 may be associated with other operations. The machine learning model 610 may be one or more machine learning models.

In another example, the training data 620 may include attributes of thousands of objects. For example, the objects may be a smart phone, person, book, newspaper, sign, car, item and/or the like. Attributes may include but are not limited to the size, shape, orientation, position of the object(s), etc. The training data 620 employed by the machine learning model 610 may be fixed or updated periodically. Alternatively, the training data 620 may be updated in real-time based upon the evaluations performed by the machine learning model 610 in a non-training mode. This is illustrated by the double-sided arrow connecting the machine learning model 610 and stored training data 620.

The machine learning model 610 may be designed to generate one or more sections of code (e.g., generate code) associated with one or more received inputs, based in part on utilizing determined contextual information. This information includes fields like a description, variables defined, data category associated with the variables and the output (e.g., programming output), and responses to generated prompts. The machine learning model 610 may be a large language model to generate representations (e.g., vector spaces), or embeddings, of one or more of the one or more inputs received. These machine learning model 610 may be trained (e.g., pretrained and/or trained in real-time) on a vast amount of textual data (e.g., associated with the one or more inputs), previous responses to one or more prompts generated, previously generated code, and/or data capture of a wide range of language patterns and semantic meanings. The machine learning model 610 may understand and represent the context of words, terms, phrases and/or the like in a high-dimensional space, effectively capturing/determining the semantic similarities between different received inputs, including descriptions and responses to prompts, even when they are not exactly the same.

Typically, such determinations by some existing systems may require a large quantity of manual annotation(s) and/or brute force computer-based annotation to obtain the training data in a supervised training framework. However, example aspects of the present disclosure may deploy a machine learning model(s) (e.g., machine learning model 610) that may be flexible, adaptive, automated, temporal, learns quickly and trainable. Manual operations or brute force device operations may be unnecessary for the examples of the present disclosure due to the learning framework aspects of the present disclosure that are implementable by the machine learning model 610. As such, this enables one or more user inputs, requests for programmable code to solve one or more problems, or other aspects of the examples of the present disclosure to be flexible and scalable to billions of users, and their associated communication devices, on a network device.

### B. Methods, Apparatuses, Systems and Computer Program Products for Risk and Compliance Artificial Intelligence Virtual Assistant

### TECHNOLOGICAL FIELD

Examples of the present disclosure may relate generally to methods, apparatuses and computer program products for providing artificial intelligence (AI) chatbots that facilitate risk mitigation and compliance.

### BACKGROUND

Some employees of social network entities may be expected to comply with various policies, procedures, standards, and applicable regulations. These may be maintained in various documents, portals, wikis, and repositories. Engineers may be expected to comply with applicable policies as they build products and security features. Currently, it takes a lot of compliance and other cross functional teams time and resources to ensure adequate compliance.

### BRIEF SUMMARY

A solution of the examples of the present disclosure provides a Governance, Risk, and Compliance (GRC) virtual assistant that may utilize Large Language Models (LLMs) to scan large data sets such as policies, procedures, standards, secure controls frameworks, National Institute of Standards and Technology (NIST) controls standards and a variety of internal documents to help social network entities and their personnel/employees achieve compliance by significantly saving time and increasing operational efficiency.

### DETAILED DESCRIPTION

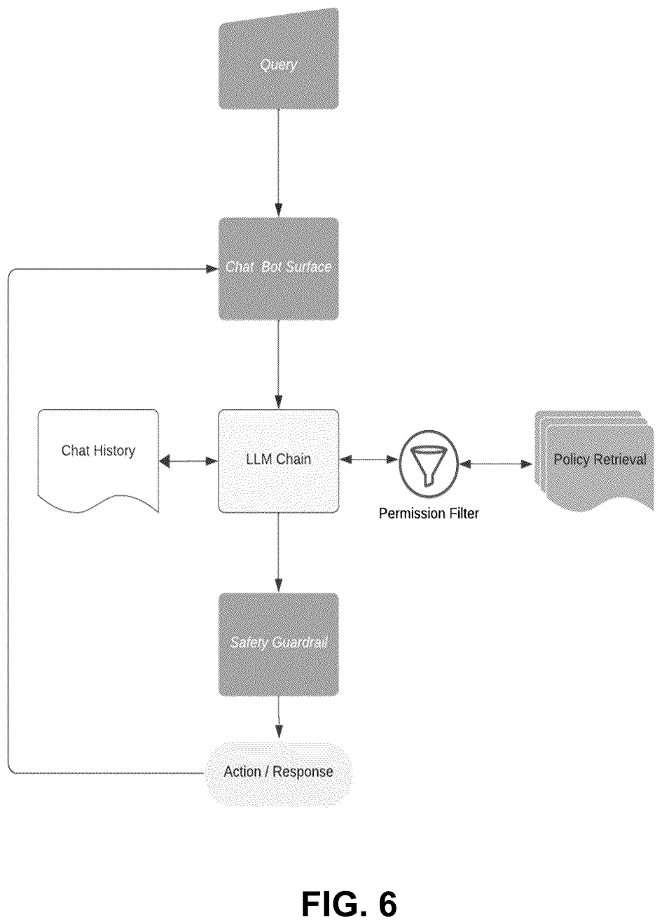

FIG. 6 illustrates an example user interface generated by the GRC chatbot in accordance with an exemplary aspect of the present disclosure.

### What is the GRC Virtual Assistant

A GRC Virtual Assistant is a Governance Risk and Compliance chatbot built using generative AI capabilities that may be utilized within an entity (e.g., in a workplace, etc.). This GRC chatbot may enable various stakeholders within entities such as, for example, social network entities such as engineers, Program Managers, Cross Functional Partners to interact with the GRC chatbot to do one or more of the following.
Understand social network policy and procedures.
Understand the risk posture of the entity.
Facilitate audit and compliance assessments.
Report risk(s).

### Features of Using the GRC Virtual Assistant

The GRC virtual assistant may be used for a variety of purposes including, but not limited to, the following.

Risk reporting—The GRC virtual assistant may provide compliance and/or risk assessments presented via one or more user interfaces of a communication device(s) to enable users to view/interact with such compliance and/or risk assessments. The GRC virtual assistant may provide these compliance and/or risk assessments based on analyzing information including, but not limited to, newsletters, network posts (e.g., social network posts), dashboards, emails, and/or the like. The GRC virtual assistant may help personnel/employees to self-serve the necessary information by interacting with the GRC virtual assistant. Examples include handling compliance calendars and issues involving dashboards.

Performing risk assessments—The GRC virtual assistant may be used by risk professionals and leaders to understand the current realized and unrealized risk(s) within a company. This may be achieved by indexing various Key Risk Indicators, existing safeguards and controls into a vector database and then leveraging LLMs to help correlate risks/issues with existing safeguards and controls.

Risk intake forms—The GRC Virtual Assistant may provide personnel/employees a mechanism to report key risks that they come across in their day-to-day tasks. In this regard, the GRC virtual assistant may provide a lightweight risk intake form through which risk may be reported in a dynamic manner.

Risk consulting—The GRC Virtual Assistant chatbot may also provide risk consulting and help personnel/employees conserve/save resources spent on emails, meetings, etc.

In this regard, the GRC Virtual Assistant may be integrated with generative AI capabilities which may utilize LLMs to scan large data sets such as, for example, policies, procedures, standards, secure controls frameworks, NIST controls standards and significantly save time, and may help scale GRC services to personnel/employees of entities and aid in operational efficiency.

### ALTERNATE EMBODIMENTS

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

As used herein, the terms “data,” “content,” “information” and similar terms may be used interchangeably to refer to data capable of being transmitted, received and/or stored in accordance with examples of the disclosure. Moreover, the term “exemplary”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
receiving, at a server, a first input specifying a programming output;
providing, using a first trained machine learning model, and based on one or more of the first input, a second input, and a third input, one or more sections of boiler plate code configured to perform basic operations of the programming output, wherein the boiler plate code comprises one or more missing portions;
assessing, via a second trained machine learning model, the first input and the programming output to determine one or more prompts to obtain information to generate one or more portions of code;
generating, via a third trained machine learning model, one or more portions of code associated with the one or more missing portions based on a fourth input; and
outputting, via user interface, a generated code associated with providing the programming output.

2. The method of claim 1, wherein the first input comprises a description that describes a problem to be solved in natural language (e.g., text).

3. The method of claim 1, wherein the one or more missing portions are traditionally written with manual code.

4. The method of claim 1, wherein the fourth input comprises one or more responses to the determined prompts.

5. The method of claim 1, wherein the generated code comprises the one or more sections of boiler plate code and the one or more portions of code generated.

6. The method of claim 1, the generated code comprises one or more comments to describe functions and processes associated with the generated code configured to aid a user in understanding the generated code.

7. The method of claim 1, wherein the processes of the first trained machine learning model, the second trained machine learning model, and the third machine learning model are performed by one machine learning model.

8. The method of claim 1, wherein the first trained machine learning model, the second trained machine learning model, and the third machine learning model are different machine learning models.

9. The method of claim 1, wherein the second trained machine learning model and the third machine learning model are trained and fine-tuned based on the generated code.

10. The method of claim 1, further comprising:
referencing a database to determine at least one of the one or more sections of boiler plate code;
transmitting locations of the one or more missing portions;
storing locations of the one or more missing portions; and
filing the one or more missing portions with the one or more portions of code generated.

11. The method of claim 1, wherein the second input may define one or more variables used to determine the programming output.

12. The method of claim 11, wherein the one or more variables may be any data category such as, floating point, Boolean, integer, string, function, vector, array, matrix, mesh, or any other suitable data category.

13. The method of claim 1, wherein the third input may define a data category associated with one or more variables and the programming output.

14. The method of claim 13, wherein the data category may be one or more of a floating point, Boolean, integer, string, function, vector, array, matrix, mesh, or any other suitable data category.

15. A method comprising:
providing a virtual assistant chatbot integrated with artificial intelligence capabilities by utilizing one or more large language models (LLMs);
causing the chatbot to scan data sets comprising policies, procedures, standards, secure controls frameworks, or National Institute of Standards and Technology (NIST) controls standards; and
providing risk or compliance guidance, presented via a user interface of a communication device, in response to one or more inquiries or based on the data sets.
